(19) United States
(12) Patent Application Publication
(10) Pub. No.: US 2006/0188252 A1
(43) Pub. Date: Aug. 24, 2006

(54) Method for determiming a link path and a corresponding unoccupied wavelength channel

(76) Inventor: Paul Schluter, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/565,684

(22) PCT Filed: Jul. 13, 2004
(86) PCT No.: PCT/EP04/51477

§ 371 Date: Jan. 24, 2006

(30) Foreign Application Priority Data
Jul. 24, 2003 (DE) 103 33 805.5

(51) Int. Cl. H04B 10/08

(52) U.S. Cl. 398/25

(57) ABSTRACT

A method for determining a link path and an unoccupied wavelength channel on the optical transmission links of said link path, for setting up a connection by means of at least one first and second network nodes within a transparent optical transmission system is provided. According to one embodiment of the method, a respective link weighting is determined for the wavelength channels of an optical transmission link, said weighting depending on the optical transmission link and on the considered wavelength channel. A connection cost value is also generated for each link path, which is available for the connection setup, and for the corresponding wavelength channel by evaluation of the at lest one link weighting and, for the connection setup, the link path with the corresponding wavelength channel, which has the minimum connection cost value, is selected.

### CROSS REFERENCE TO RELATED APPLICATIONS

This application is the US National Stage of International Application No. PCT/EP2004/051477, filed Jul. 13, 2004 and claims the benefit thereof. The International Application claims the benefits of German application No. 10333805.5 DE filed Jul. 24, 2003, both of the applications are incorporated by reference herein in their entirety.

### FIELD OF INVENTION

This invention relates to a method for determining a connection path and an associated unoccupied wavelength channel.

### BACKGROUND OF INVENTION

The rapid growth of the internet has resulted in the demand for available transmission bandwidth increasing out of all proportion in recent years. Progress in the development of optical transmission systems, in particular with transmission systems based on Wavelength Division Multiplexing (WDM) technology, has contributed to the implementation of high transmission bandwidths. As a result transparent optical transmission systems, which allow the complete transmission of data signals in the optical range, i.e. without opto-electrical or electro-optical conversion of the data signals, have now acquired a particular importance.

Transparent optical transmission systems are made up of a number of optical network nodes connected together via optical transmission links. Optical wavelength channels are hereby provided to transmit the optical data signals, in particular optical WDM signals. Such a transparent optical transmission system allows optical connections to be set up between two users, with a selected connection path through the transparent optical system being assigned for this purpose to every optical connection as well as an available, i.e. unoccupied, wavelength channel on this connection path. When the connection is being set up, a connection path is determined with a continuously available wavelength channel, via which the connection can be set up. If no wavelength conversion arrangements are provided in the individual optical network nodes, to set up a connection between a first network node and a second network node connected to this first network node for example via a number of further optical network nodes on the individual optical transmission links of the selected connection path, the same wavelength channel in each instance must not be occupied by any further optical connection.

An optical connection path and a wavelength channel available on this should therefore be determined first to set up a new optical connection. This problem is known in specialist circles as the “dynamic RWA” (routing and wavelength assignment) problem. There is also a “static RWA” problem, where all connection requests are known simultaneously—see also Zang et al “Dynamic Lightpath Establishment in Wavelength-Routed WDM networks”, IEEE Communication Magazine, September 2001, pages 100 to 108.

To resolve the dynamic RWA problem, knowledge of the occupancy of the wavelength channels within the transparent optical transmission system is required so that a connection path with wavelength channels that are still free can be determined, at the latest when a connection request is being processed. A priori knowledge of network load in the transparent optical transmission system should thereby be as reliable as possible, to prevent incorrect connection set-up in most cases.

When the connection is actually being set up, the determined wavelength channel is occupied on all optical transmission links of the connection path and is therefore no longer available for further connection requests. We will look below at the instance where current network load, i.e. occupancy of all the wavelength channels on the various optical transmission links of the transparent optical transmission system, is known. The following criteria should provide effective resolution of the dynamic RWA problem under these conditions:

the lowest possible probability of blocking for current and also all future connection requests;

greatest possible effectiveness of the solution.

The dynamic RWA problem is for example resolved by determining a connection path first and then an available, i.e. as yet unoccupied, wavelength channel on the selected connection path. Alternatively a wavelength channel within the transparent optical transmission system can be selected first and a suitable connection path can then be determined after that.

Connection Path First, Then Wavelength Channel

A method is known from the publication “Importance of wavelength conversion in an optical network”, John Strand, Robert Doverspike and Guangzhi Li in Optical Networks Magazine May/June 2001, in which the k shortest connection paths in respect of link weightings are first determined between the end points of a planned connection. Current occupancy of the wavelength channels is investigated on the determined connection paths and then evaluated based on a figure of merit. The most favorable connection path is then selected based on the figure of merit. The following heuristics are for example proposed for the figure of merit and selection of the wavelength channels.

“first fit”: the wavelength channels are ordered arbitrarily, i.e. provided with an index. For connection set-up, the connection path is selected on which the wavelength channel with the lowest possible index is still unoccupied.

“most-used wavelength”: a wavelength channel is better, the more frequently it is used in the transmission system as a whole to set up connections. There is also a more complicated method, in which evaluation takes place using a “route similarity ratio”.

The main disadvantage of this method is that only a specific number k of connections is considered from the outset. It is of course possible that no or only one wavelength channel with a poor figure of merit is free on the considered k connection paths, while favorable wavelength channels are still available on connection paths that are not being considered, which are just as long or only insignificantly longer than the k shortest connection paths. This disadvantage has a particularly serious impact, as k should be as small as possible within the optical transmission system to limit computing costs.

Wavelength Channel First, Then Connection Path

The RWA problem is first reformulated here, in that the transparent optical system, which comprises a plurality of connection paths, in particular WDM connection paths, is first transformed into a number of virtual optical transmission sub-networks of identical structure, with just one wavelength channel being assigned to each of these virtual optical transmission sub-networks (see FIG. 2). Each transmission link in one of the virtual optical transmission sub-networks can be used by maximum one connection. These virtual optical transmission sub-networks are not connected together, i.e. there is no provision for wavelength conversion within the virtual optical transmission sub-networks. The user access arrangements are linked to all the virtual optical transmission sub-networks. The RWA problem now involves finding a connection path in the resulting optical transmission system, with the wavelength channel already being determined by the selected virtual optical transmission sub-network. To determine a suitable connection path, the individual virtual optical transmission sub-networks are investigated one after the other, for example by means of the Dijkstra algorithm, to establish whether a connection path satisfying the above conditions is available to set up a connection between the two users. The first connection path found in one of the virtual optical transmission sub-networks is used to set up the connection. The following heuristics for example are proposed for the sequence, in which the various virtual optical transmission sub-networks are investigated:
“fixed”: the wavelength channels have a fixed sequence;
“pack”: the wavelength channels are ordered by decreasing frequency of use in the optical transmission system as a whole;
“exhaustive” all the virtual optical transmission sub-networks are always searched and the shortest of all the connection paths (together with the associated wavelength channel) is selected.

Disadvantageously with the “fixed” and “pack” heuristics a connection path is sometimes selected, which uses a favorable wavelength channel but the connection path of said channel is disproportionately, i.e. it takes up very many resources within the transparent optical transmission system. Conversely with the “exhaustive” heuristic the shortest connection path is always selected, even if the assigned wavelength channel is unfavorable, even though an only slightly longer connection path with a much more favorable wavelength channel might be available. In the context in question favorable wavelength channels are wavelength channels, which are already used frequently in the optical transmission system in question. These should be used even more frequently to reduce blocking rates, in order to leave other wavelength channels unused. A compromise between the two objectives of favorable wavelength channel, i.e. low blocking rate for subsequent connection requests, and short path, i.e. low resource use, cannot be achieved.

### SUMMARY OF INVENTION

An object of the present invention is to specify an improved method for determining a connection path and an unoccupied wavelength channel on the optical transmission links of the connection path for setting up a connection within a transparent optical transmission system, said method allowing a lower blocking rate and low level of resource use within the optical transmission system.

The object of the invention is achieved by the features of the independent claims. Advantageous developments are specified in the dependent claims.

The significant aspect of the method for determining a connection path and an unoccupied wavelength channel on the optical transmission links of said connection path for setting up a connection via at least a first and a second network node within a transparent optical transmission system with a plurality of further network nodes connected together via optical transmission links is that a link weighting that is a function of the optical transmission link and the wavelength channel in question respectively is determined for the wavelength channels of an optical transmission link. A connection cost value is then also generated for every connection path available for connection set-up and the associated wavelength channel by evaluating the at least one link weighting and the connection path having the minimum connection cost value is then selected with the associated wavelength channel for setting up the connection. With the claimed method the two criteria favorable wavelength and characteristics of the transmission link, such as length, attenuation characteristics or even frequency of use, are advantageously jointly taken into account in a link weighting that is a function of said criteria when determining the connection path and an associated wavelength channel. Already used wavelength channels of a transmission link are for example hereby assigned a link weighting with the value infinite. A connection cost value is generated from the determined link weightings of a connection path and the associated wavelength channel, which specifies the costs or resource outlay required to set up the connection via the connection path and wavelength channel in question. Based on the generated connection cost values the connection path having a minimum connection cost value is selected with the associated wavelength channel to set up the connection. This avoids the disadvantages of the methods known from the prior art, in particular the high computing outlay required to determine the connection path including the associated wavelength channel.

A further advantage of the claimed method is that a network-wide channel weighting is assigned to each wavelength channel and the network-wide channel weighting is determined with the aid of a channel weighting function. A network-wide channel weighting that can be defined with simple technical means is hereby particularly advantageously determined.

The transparent optical transmission system is advantageously split into a number of virtual optical transmission sub-channels, each having only one optical wavelength channel, with the claimed link weightings being assigned to the transmission links present in the transmission sub-networks and the transmission sub-networks being evaluated to determine the connection path having the minimum connection cost value and the associated wavelength channel. By splitting the transparent optical transmission system into virtual optical transmission sub-networks each with one wavelength channel and by assigning the claimed link weightings it is possible to continue to use algorithms that are already known for path searching within a communication network, such as the Dijkstra algorithm, whilst deploying the claimed method.

It is particularly advantageous to determine the link weighting for each transmission link and wavelength channel according to the following formula:
d_{i,r}=f(i)*dᵣ
where
i=number of wavelength channel
r=number of transmission link
f(i)=channel weighting function
dᵣ=position parameter.

The channel weighting function hereby represents a function that is dependent on the respective wavelength channel, with embodiments that are advantageous according to the invention being proposed. The channel weighting function can for example be implemented as a linear function that is dependent on the respective wavelength channel with the form
f(i)=a+b*i
where
i=number of wavelength channel
a=a first parameter
b=a second parameter.

Alternatively the occupancy status of the wavelength channels on the transmission links already occupied by further connections can be taken into account by means of the channel weighting function. To this end the current degree of usage of each wavelength channel within the transparent optical transmission system is determined or estimated. A possible form of such a channel weighting function as a function that is dependent on the degree of usage of the respective wavelength channel could for example be implemented as follows:
f(i)=g(A_{i,occupied}/A_{i,overall})
where
i=number of wavelength channel
A_{i,occupied}=number of transmission links on which the wavelength channel i is occupied
A_{i,overall}=number of all transmission links on which the wavelength channel i is physically available
G( . . . )=any function.

A monotonic function g( ) has the advantage that wavelength channels that are already frequently used are preferred when determining a connection path required for setting up a new connection and the associated wavelength channel.

Also when determining the position parameter derived from the respective optical transmission link the length of the transmission link or the delay caused by the transmission link or further technically or economically relevant parameters of the optical transmission link are advantageously taken into account.

### BRIEF DESCRIPTION OF THE DRAWINGS

Exemplary embodiments of the claimed method are described in more detail below with reference to the accompanying drawings, in which:

FIG. 1 shows an example of a schematic illustration of a transparent optical transmission system,

FIG. 2 shows a schematic illustration of the transparent optical transmission system transformed into a number of virtual optical transmission sub-systems,

FIG. 3 shows a schematic illustration of the assignment of the claimed link weightings within the virtual optical transmission sub-systems and

FIG. 4 shows an example of a schematic illustration of the occupancy statuses of a transparent optical sub-system with three wavelength channels.

### DETAILED DESCRIPTION OF INVENTION

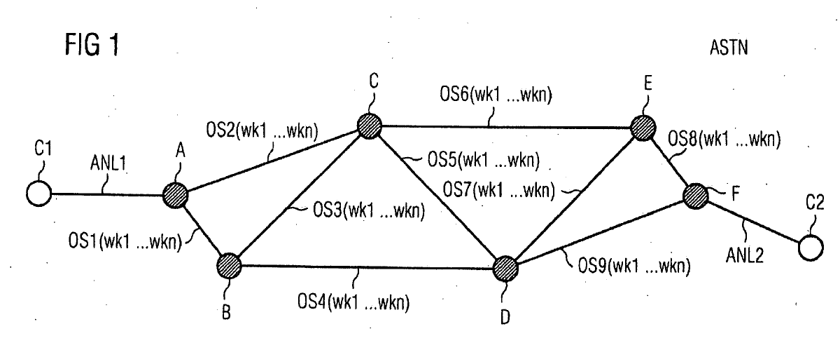

FIG. 1 shows a transparent optical transmission system ASTN (in this instance an automatically switched transport network), having a plurality of network nodes A, B, C, D, E, F connected together via optical transmission links OS1 to OS9. User access arrangements, in particular a first and second client arrangement C1, C2, are also shown by way of an example, being linked to at least one of the network nodes A, B, C, D, E, F of the transparent optical transmission system ASTN. In the exemplary embodiment in question a first to a sixth network node A to F are provided, with the first network node A being connected via a first optical transmission link OS1 to the second network node B and via a second optical transmission link OS2 to the third network node C. The second network node B is for its part connected via a third optical transmission link OS3 to the third network node C and via a fourth optical transmission link OS4 to the fourth network node D. The third network node C is also linked via a fifth optical transmission link OS5 to the fourth network node D and via a sixth optical transmission link OS6 to the fifth network node E, which is connected via a via a seventh optical transmission link OS7 to the fourth network node D and via an eighth optical transmission link OS8 to the sixth network node F. The fourth and sixth network nodes D, F are connected together via a ninth optical transmission link OS9. In addition the first client arrangement C1 is linked to the first network node A via a first access line ANL1 and the second client arrangement C2 is linked to the sixth network node F via a second access line ANL2. The client arrangements C1, C2 can for example be configured as SDH, ATM or IP client arrangements, e.g. as IP routers, (SDH=Synchronous Digital Hierarchy, ATM=Asynchronous Transfer Mode, IP=Internet Protocol).

The WDM data transmission method (WDM=Wavelength Division Multiplex) for example is also used to transmit optical signals os within the transparent optical transmission system ASTN. Wavelength division multiplex technology can be used to transmit a number of optical signals os, in particular WDM channels, simultaneously via every optical transmission link OS1 to OS9 available in the transparent optical transmission system ASTN using different wavelength channels wk1 to wkn in each instance. To this end the optical transmission links OS1 to OS9, which are made up for example of an optical fiber bundle or one or a number of individual optical fibers, each have a number of wavelength channels wk1 to wkn, whereby the number of wavelength channels wk1 to wkn can vary from optical transmission link to optical transmission link. After the connection has been set up between the first and second client arrangements C1, C2, the optical signals os are transmitted via one of the first to nth wavelength channels wk1 to wkn. In the exemplary embodiment shown each of the first ninth optical transmission links OS1 to OS9 has n wavelength channels wk1 to wkn.

The transparent optical transmission system ASTN shown in FIG. 1 is transformed into a number of virtual optical transmission sub-networks Sub1 to Subn, each having only one optical wavelength channel wk1 to wkn, with each virtual optical transmission sub-network Sub1 to Subn having one wavelength channel wk1 to wkn assigned network-wide.

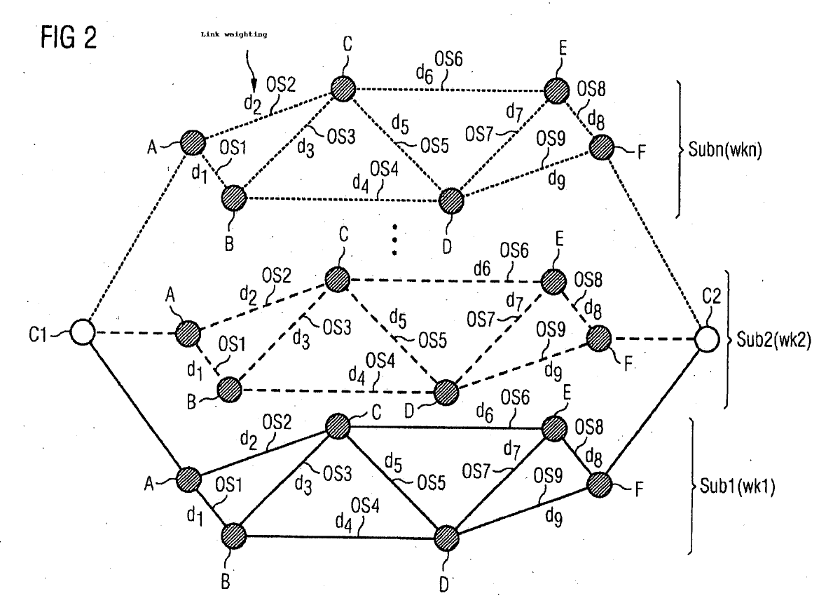

FIG. 2 shows an example of a schematic illustration of the transparent optical transmission system ASTN in FIG. 1 after transformation into a first, second to nth virtual optical transmission sub-network Sub1 to Subn, with the first wavelength channel wk1 being provided within the first virtual transmission sub-network Sub1 for transmission of the optical signals os on the optical transmission links OS1 to OS9. The second wavelength channel wk2 is provided within the second virtual transmission sub-network Sub2 and the nth wavelength channel wkn is provided within the nth virtual transmission sub-network Subn to transmit the optical signals os. The virtual optical transmission sub-networks in between Sub3 to Subn−1 are shown with a dotted line.

Such a schematic illustration shows the reformulation of the dynamic RWA problem so that it can be more easily resolved. For example such a reformulation of the dynamic RWA problem can be used to determine suitable connection paths with unoccupied wavelength channels wk1 to wkn for the required connection set-up with the aid of known algorithms, e.g. the Dijkstra algorithm. The virtual optical transmission sub-networks Sub1 to Subn hereby each have the same structure as the original optical transmission system ASTN, i.e. the same number of network nodes A to F and the same number of optical transmission links OS1 to OS9.

The individual virtual optical transmission sub-networks Sub1 to Subn are not connected together, i.e. the optical transmission system ASTN in question does not have a wavelength converter. The individual transmission sub-networks Sub1 to Subn are connected respectively via just one network node A, F to the first or second client arrangements C1, C2. Also a link weighting dᵣ is assigned to each optical transmission link OS1 to OS9 respectively, corresponding to the position parameter dᵣ in the exemplary embodiment in question. When determining the position parameter dᵣ derived from the respective optical transmission link OS1 to OS9, the length of the transmission link OS1 to OS9 or the delay caused by the transmission link OS1 to OS9 or further technically or economically relevant parameters of the respective optical transmission link OS1 to OS9 are for example taken into account. The same link weighting dᵣ is hereby assigned to every optical transmission link OS1 to OS9 within the virtual optical transmission sub-networks Sub1 to Subn, i.e. in the first transmission sub-network Sub1 the first optical transmission link OS1 has the same link weighting dᵣ as for example within the second virtual optical transmission sub-network Sub2. The index r indicates the number of the optical transmission link OS1 to OS9 in each instance.

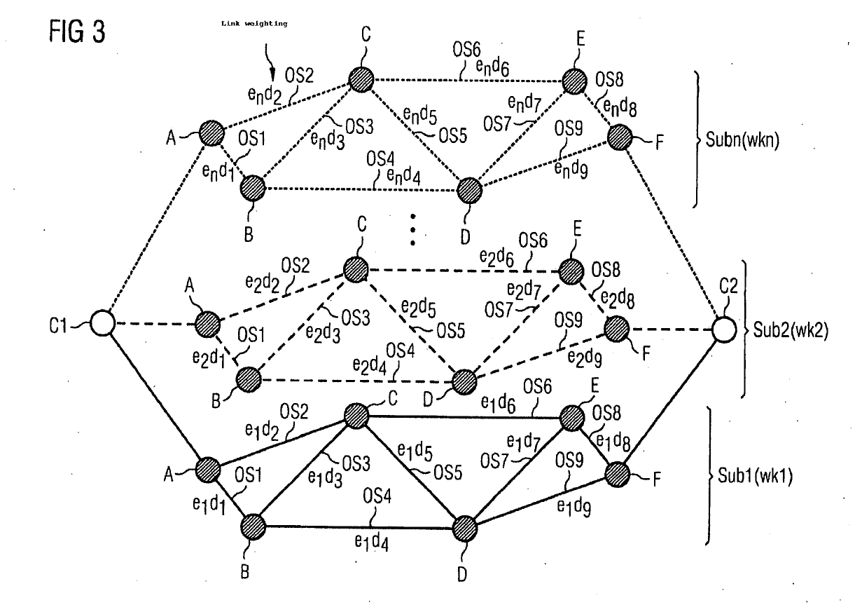

FIG. 3 describes the first step of the claimed method based on the layer model already shown in FIG. 2. The optical transmission system ASTN transformed into n virtual optical transmission sub-networks Sub1 to Subn is investigated with the aid of a suitable search algorithm, for example the Dijkstra algorithm, to establish whether a connection path satisfying the basic conditions required for connection set-up is available between the first and second client arrangements C1, C2 for example. According to the proposed solution, a link weighting d_{i,r} that is a function of the optical transmission link and the wavelength channel in question is determined individually for each optical transmission link OS1 to OS9 and each wavelength channel wk1 to wkn of the optical transmission system ASTN, i.e. a link weighting d_{i,r,} which is a function of the wavelength channel wk1 to wkn in question and the characteristics of the optical transmission link OS1 to OS9, is assigned respectively to each optical transmission link OS1 to OS9 of the virtual optical transmission sub-networks Sub1 to Subn. The new link weighting d_{i,r} for each transmission link OS1 to OS9 and wavelength channel wk1 to wkn is determined according to the following formula:
d_{i,r}=f(i)*dᵣ

The index i of the link weighting d_{i,r} refers to the number i of the wavelength channel wk1 to wkn and the index r the number r of the transmission link OS1 to OS9. The link weighting d_{i,r} is generated according to the formula from the product of a channel weighting function f(i) and the position parameter dᵣ. The link weighting d_{i,r} is therefore made up of a position parameter dᵣ taking into account the position r in the original transparent optical transmission system ASTN and a channel weighting eᵢ, which is a function of the respective wavelength channel wkn1 to wkn. The channel weighting eᵢ refers to the value of the channel weighting function f(i) for the wavelength channel wk1 to wkn with index i. The channel weighting eᵢ is determined network-wide with the aid of the channel weighting function f(i) and assigned to the associated virtual optical transmission sub-network Sub1 to Subn. In FIG. 3 the determined link weightings d_{i,r} are shown respectively as a product of the network-wide channel weighting eᵢ and the position parameter dᵣ and are assigned to the associated optical transmission links OS1 to OS9 in the individual virtual optical transmission sub-networks Sub1 to Subn. The first virtual optical transmission sub-network Sub1 hereby has link weightings d_{i,r,} which are shown as a product of the first network-wide channel weighting eᵢ and the respectively associated position parameter dᵣ. Similarly the second to nth virtual optical transmission sub-networks Subn have link weightings d_{i,r}, which are respectively a product of the second to nth network-wide channel weighting e₂ to eₙ and the respectively associated position parameter dᵣ.

To determine the network-wide channel weighting eᵢ, a channel weighting function f(i) that is dependent on the respective wavelength channel wk1 to wkn is generated. Such a channel weighting function f(i) can be implemented as a function that is linearly dependent on the respective wavelength channel wk1 to wkn with the form
f(i)=a+b*i
where
i=number of wavelength channel
a=a first parameter
b=a second parameter.

Alternatively the occupancy status of the wavelength channels wk1 to wkn on the transmission links OS1 to OS9 already occupied by connections can also be taken into account by means of the channel weighting function f(i), with the current degree of usage of each optical wavelength channel wk1 to wkn within the transparent optical transmission system being determined or estimated to this end.

A channel weighting function f(i) that is dependent on the degree of usage of the respective wavelength channel wk1 to wkn has the following form for example:
f(i)=g(A_{i,occupied}/A_{i,overall})
where
i=number of wavelength channel
A_{i,occupied}=number of transmission links on which the wavelength channel i is occupied
A_{i,overall}=number of all transmission links on which the wavelength channel i is physically available
G( . . . )=any function.

The network-wide channel weightings eᵢ determined with the aid of the channel weighting functions f(i) mentioned are assigned, as indicated in FIG. 3, respectively to the associated optical transmission links OS1 to OS9 or the associated virtual optical transmission sub-networks Sub1 to Subn. This assignment is implemented for example with the aid of a centrally disposed control unit. The network-wide channel weighting eᵢ hereby indicates in particular that some wavelength channels wk1 to wkn are more favorable for a planned connection set-up than others.

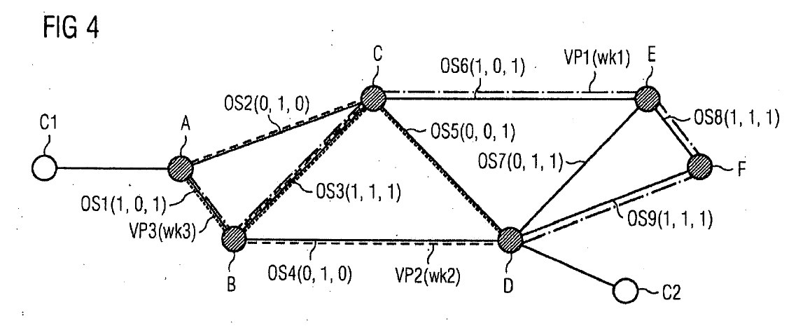

FIG. 4 sets out the advantages of the proposed method using the example of the transparent optical transmission system ASTN in question with a first, second and third wavelength channel wk1 to wk3 for each optical transmission link OS1 to OS9. In contrast to the transparent optical transmission system ASTN considered before, the second client arrangement C2 is linked via the second access line ANL2 to the fourth network node D. A suitable connection path VP and an associated wavelength channel wk1 to wk3 are determined below for setting up a connection between the first and second client arrangements C1, C2.

In the transparent optical transmission system ASTN in question the first to third wavelength channels wk1 to wk3 of the first to ninth optical transmission links OS1 to OS9 are occupied as follows, with a logical 0 indicating occupancy of the wavelength channel wk1 to wk3 in question and a logical 1 indicating the non-occupancy of the wavelength channel wk1 to wk3 in question.

TABLE 1

| Optical transmission link | wk1 | wk2 | wk3 |
|---|---|---|---|
| OS1 | 1 | 0 | 1 |
| OS2 | 0 | 1 | 0 |
| OS3 | 1 | 1 | 1 |
| OS4 | 0 | 1 | 0 |
| OS5 | 0 | 0 | 1 |
| OS6 | 1 | 0 | 1 |
| OS7 | 0 | 1 | 1 |
| OS8 | 1 | 1 | 1 |
| OS9 | 1 | 1 | 1 |

The three wavelength channels in this example are identical with regard to transmission characteristics and their arrangement is arbitrary.

To set up a connection between the first network node A and the fourth network node D, a first, second and a third connection path VP1, VP2, VP3 are possible on the optical transmission links OS1 to OS9 according to the occupancy statuses of the first to third wavelength channels wk1 to wk3.

The first connection path VP1 passes from the first network node A via the first optical transmission link OS1 to the second network node B and from there via the third optical transmission link OS3 to the third network node C. From the third network node C the first connection path VP1 continues via the sixth optical transmission link OS6 to the fifth network node E and from there via the eighth optical transmission link OS8 to the sixth network node F. Finally the first connection path leads from the sixth network node F via the ninth optical transmission link OS9 to the fifth network node D. The first connection path therefore passes via five transmission links OS1, OS3, OS6, OS8, OS9. On the first connection path VP1 the first wavelength channel is still unoccupied and therefore available for the planned connection set-up.

The second connection path VP2 passes from the first network node A via the second optical transmission link OS2 to the third network node C and from there via the third optical transmission link OS3 to the second network node B. From the second network node B the second connection path VP2 passes via the fourth optical transmission link OS4 to the fourth network node D. The second connection path VP2 therefore has three optical transmission links OS2, OS3, OS4 and the second wavelength channel wk2 is available for connection set-up.

The third connection path VP3 passes from the first network node A also via the first optical transmission link OS1 to the second network node B and from this via the third optical transmission link OS3 to the third network node C. The last segment of the third connection path VP3 passes from the third network node C via the fifth optical transmission link OS5 to the fourth network node D. Overall the third connection path VP3 has three optical transmission links OS1, OS3, OS5, on which the third wavelength channel wk3 is unoccupied in each instance and therefore available for a connection set-up.

Thus for setting up a connection from the first client arrangement C1 via the transparent optical transmission system ASTN to the second client arrangement C2 there are three connection paths VP1 to VP3, having different lengths, i.e. numbers of optical transmission links OS1 to OS9. These three connection paths are contrasted in the table below.

TABLE 2

| | | | | Connection | Connection |
|---|---|---|---|---|---|
| Connection | Wavelength | | Degree of usage | costs | costs |
| path | channel i | Length l | bᵢ = A_{i,occupied}/A_{i,overall} | (l + i) · l | (l − bᵢ) · l |
| VP1 | 1 | 5 | 4/9 | 10 | 25/9 |
| VP2 | 2 | 3 | 3/9 | 9 | 18/9 |
| VP3 | 3 | 3 | 2/9 | 12 | 21/9 |

In addition to the number i of the associated wavelength channel wk1 to wk3 and the length l of the connection path VP1 to VP3, this table also contains the degree of usage bᵢ=A_{i,occupied}/A_{i,overall} of the respective virtual optical transmission sub-network Sub1 to Sub3. In the exemplary embodiment shown the second connection path VP2 is the most favorable choice for setting up the connection between the first and second client arrangements C1, C2. The second connection path VP2 is clearly shorter than the first connection path VP1 and the associated second transmission sub-network Sub2 has a higher degree of usage bᵢ than the third connection path VP3 of the same length l.

If dᵣ=l is now selected as the position parameter for the first to ninth optical transmission link OS1 to OS9, the connection costs are obtained by adding the link weightings d_{i,r} and thus as a product of the channel weighting function f(i) and the length l of the respective connection path VP1 to VP3. With a linear channel weighting function that is only dependent on the number i of the respective wavelength channel wk1 to wk3
f(i)=l+i,
where the transmission links OS1 to OS9 in the first virtual optical transmission sub-network Sub1 are weighted in a ratio of 1:2 compared with those in the third virtual optical transmission sub-network Sub3, the connection costs are (l+i).l for a connection path of length l using the wavelength channel i. The connection cost values resulting for the exemplary embodiment shown are set out in table 2.

Alternatively a further simple channel weighting function f(i) that is only dependent on the degree of usage bᵢ can be selected with the following form:
f(i)=(l-bᵢ).

By implementing this channel weighting function f(i) the transmission sub-networks Sub1 to Sub3 with a high degree of usage are particularly advantageously preferred to those with a low degree of usage. The connection costs (l−bᵢ).l shown in table 2 thus result. Both examples with different channel weighting functions give the second connection path VP2 as the connection path with the lowest connection costs.

In contrast methods known from the prior art produce different, less satisfactory results. Prioritization of the wavelength channels wk1 to wk3 means that use of the “fixed” heuristic results in the first connection path VP1 as the available connection path with the first wavelength channel wk1. This has the disadvantage that clearly the longest connection path VP1 is selected.

The “pack” heuristic only differs from “fixed” in that the ordering of the wavelength channels wk1 to wk3 is not fixed but is a function of the degree of usage bᵢ. In the present example this order is the same as for “fixed” and the “pack” heuristic therefore also results in the unfavorable first connection path VP1.

In contrast the “exhaustive” heuristic results in the second and third connection paths VP2, VP3, as these two connection paths VP2, VP3 have the same and the shortest length l=3. It is however not determined which of these two alternatives is selected. A serious disadvantage of the “exhaustive” heuristic is exhibited in optical transmission systems, which are larger and therefore more complex than the exemplary embodiment shown. Here two connection paths of very similar length (l=11 and 12) can be available for selection, with the shorter connection path being assigned a much more unfavorable wavelength channel than the only slightly longer connection path. The “exhaustive” heuristic then results in the shorter connection path, which is generally clearly more unfavorable than the slightly longer connection path. In contrast the method proposed here allows a compromise between the two criteria short length and favorable wavelength channel.

The proposed method can therefore be used with directed and undirected connection paths.

1-11. (canceled)

12. A method for determining a connection path and a wavelength channel that is unoccupied on optical transmission links of the connection path within a transparent optical network system, comprising:
generating a connection cost for each connection path available for connection setup and the associated wavelength channel;
selecting the connection path with the associated wavelength channel having the minimum connection cost value;
determining for each wavelength channel of the optical transmission link, a link weighting that is a function of the characteristics of the optical transmission link and the respective wavelength channel; and
generating the connection cost value by evaluating at least one link weighting.

13. The method according to claim 12, wherein a network-wide channel weighting is assigned to each wavelength channel.

14. The method according to claim 13, wherein the network-wide channel weighting is determined via a channel weighting function.

15. The method according to claim 12, wherein the transparent optical transmission system is split into a plurality of virtual optical transmission sub-systems, each subs-system having a single optical wavelength channel with the determined link weightings assigned to the transmission links available in the sub-system and the sub-system is evaluated to determine the connection path having the minimum connection cost value and the associated wavelength channel.

16. The method according to claim 14, wherein the link weighting is determined via the following mathematical formula:
d_{i,r}=f(i)*dᵣ
where
i=wavelength channel number
r=transmission link number
f(i)=channel weighting function
dᵣ=position parameter.

17. The method according to claim 15, wherein the link weighting determination is achieved via the following mathematical formula:
d_{i,r}=f(i)*dᵣ
where
i=wavelength channel number
r=transmission link number
f(i)=channel weighting function
dᵣ=position parameter.

18. The method according to claim 14, wherein the channel weighting function is a linear function that is dependent on the respective wavelength channel.

19. The method according to claim 18, wherein the channel weighting function has the mathematical form:
f(i)=a+b*i
where
a=a first parameter
b=a second parameter
i=wavelength channel number.

20. The method according to claim 14,
wherein a current degree of usage of each optical wavelength channel within the transparent optical transmission system is determined or estimated, and
wherein an occupancy status of the wavelength channels occupied by further connections is evaluated via the channel weighting function and the current degree of usage.

21. The method according to claim 20, wherein the channel weighting function is dependent on the degree of usage of the respective wavelength channel with the mathematical form:
f(i)=g(A_{i,occupied}/A_{i,overall})
where
g( . . . )=any function
A_{i,occupied}=number of transmission links on which the wavelength channel i is occupied.
A_{i,overall}=number of all transmission links on which the wavelength channel i is physically available.

22. The method according to claim 16, wherein the length of the transmission link or the delay caused by the transmission link are considered when determining the position parameter derived from the respective optical transmission link.

23. The method according to claim 12, wherein each link weighting in a connection path are added to generate the connection cost value.
